(19) United States
(12) Patent Application Publication
(10) Pub. No.: US 2008/0319131 A1
(43) Pub. Date: Dec. 25, 2008

(54) Electrically Conductive Polymers and Raft Polymerization

(76) Inventors: Richard D. McCullough, Pittsburgh, PA (US); Mihaela C. Iovu, Dallas, TX (US)

Correspondence Address: FOLEY AND LARDNER LLP;SUITE 500, 3000 K STREET NW, WASHINGTON, DC, 20007, US

(21) Appl. No.: 12/064,618

(22) PCT Filed: Aug. 25, 2006
(86) PCT No.: PCT/US2006/033324

§ 371 Date: Sep. 2, 2008

Related U.S. Application Data
(60) Provisional application No. 60/711,417, filed on Aug. 26, 2005.

(51) Int. Cl. C08L 81/02; C08L 53/00

(52) U.S. Cl. 525/90; 525/535; 525/418; 525/420

(57) ABSTRACT

Electrically conductive polymers including block copolymers, polythiophene copolymers, and regioregular polythiophene copolymers, prepared by controlled radical polymerization including RAFT and NMP polymerization methods. Polymers having low metal content can be prepared. Method of synthesizing polythiophene polymers and copolymers using RAFT and NMP polymerization are also provided. Regioregular polythiophenes are preferred. Blends with polythiophenes and non-conducting polymers can be prepared. Applications include PLEDs, sensors, and optoelectronics.

### RELATED APPLICATIONS

This application claims priority to U.S. provisional application Ser. No. 60/711,417 filed Aug. 26, 2005 to McCullough et al, which is hereby incorporated by reference in its entirety.

### STATEMENT REGARDING FEDERALLY SPONSORED RESEARCH OR DEVELOPMENT

This work was carried out with support from the Federal government grant NSF CHE-0415369. The government reserves certain rights in the invention.

### BACKGROUND

Polythiophenes constitute an important class of conjugated polymers or electrically conductive polymers which have conjugated backbones. Other examples include polyacetylene, polyaniline, polypyrrole, polyphenylene vinylene, and derivatives thereof. For example, alkyl substituted polythiophenes are chemically and thermally stable materials which makes them attractive candidates for applications such as optoelectronics and organic light emitting diodes (OLEDs) or polymer light emitting diodes (PLEDs). See, for example, Skotheim, T. A.; Elsenbaumer, R. L.; Reynolds, J. R., Handbook of Conducting Polymers, 2^{nd} ed., Marcel Dekker: New York, 1998; and Nalwa, H. S. Handbook of Organic Conductive Molecules and Polymers, Wiley, New York, 1997. Block copolymers having conjugated segments also can be conducting polymers.

Synthesis of regioregular poly(3-alkylthiophenes) (PATs), first discovered by McCullough et. al., resulted in the formation of substantially defect-free head-to-tail coupled PATs with greatly improved electronic and photonic properties over their regio-random analogs. Methods of synthesizing regioregular poly(3-alkylthiophenes) can be found, for example, in U.S. Pat. No. 6,166,172 to McCullough et. al. issued Dec. 26, 2000; and U.S. Pat. No. 6,602,974 to McCullough et. al. issued Aug. 5, 2003, both incorporated hereby by reference. Information on regioregular PATs and methods of their synthesis can be also found in the following publications: 1) McCullough, R. D. Adv. Mat. 1998, 10, 93; 2) McCullough, R. D.; Lowe, R. S. J. Chem. Soc., Chem. Commun. 1992, 70; 3) McCullough, R. D.; Lowe, R. D.; Jayaraman, M.; Anderson, D. L. J. Org. Chem. 1993, 58, 904; 4) Bjørnholm, T. B.; Greve, D. R.; Reitzel, N.; Kjaer, K.; Howes, P. B; Jayaraman, M.; Ewbank, P. C.; McCullough, R J. Am. Chem. Soc. 1998, 120, 7643; 5) Bjørnholm, T. B; Hassenkam, T.; Greve, D. R.; McCullough, R. D.; Jayaraman, M.; Savoy, S. M.; Jones, C. E.; McDevitt, J. T. Adv. Mater. 1999, 11, 1218; 6) Reitzel, N.; Greve, D. R.; Kjaer, K.; Howes, P. B; Jayaraman, M.; Savoy, S. M.; McCullough, R. D.; McDevitt, J. T.; Bjørnholm, T. B. J. Am. Chem. Soc. 2000, 122, 5788; 7) McCullough, R. D.; Lowe, R. S.; Khersonsky, S. M. Adv. Mater. 1999, 11, 250; 8) Loewe, R. S.; Ewbank, P. C.; Liu, J.; iZhai, L.; McCullough, R. D. Macromolecules 2001, 34, 4324, which are all incorporated hereby by reference in their entirety.

Improved synthetic methods are needed for electrically conductive polymers including polythiophenes and regioregular polythiophenes. For example, better polymer hybrid structures such as better block copolymers, graft copolymers, and blends thereof are needed. Controlled/living radical polymerization (CRP) methods developed in the last few years has allowed the synthesis of well defined polymers and copolymers with controlled molecular weights, narrow molecular weight distributions, desired functionality and topology. In general, the CRP methods rely on establishment of a dynamic equilibrium between a low concentration of active propagating chains and a predominant amount of dormant chains that are unable to propagate or terminate as a means of extending the lifetime of the propagating chains. Examples of CRP methods include nitroxide mediated radical polymerization (NMRP), atom transfer radical polymerization (ATRP), and reversible addition-fragmentation chain transfer polymerization (RAFT).

ATRP has been applied for synthesizing polythiophene block copolymers. See U.S. Pat. No. 6,602,974 to McCullough et. al. issued Aug. 5, 2003, incorporated hereby by reference in its entirety. Although ATRP proved to be a powerful method of polythiophene synthesis, it can have some relative drawbacks. For example, ATRP generally uses a transition metal complex (Cu or Ru) as catalyst which can be poisoned by thiophene during synthesis. Metals are also undesired in many electronic applications. Also, Cu(II) or Ru(III) generated during ATRP may possibly act as a dopant for poly(3-hexylthiophene), thus reducing its solubility in the reaction media, which is undesirable as the use of Cu(II) and Ru(III) for polymer doping can reduce their concentration as deactivators of the ATRP process and thereby create problems with termination reactions of the radical polymerization. Thus, new synthetic methods are generally needed. Particular interest exists in making highly water soluble conductive polymers.

Rod-coil block copolymers are also important for generating novel properties from self-assembling morphologies with well-defined nanostructures.

### SUMMARY

New polymer compositions and synthetic methods for electrically conductive polymers are provided.

One important embodiment is a polythiophene copolymer composition comprising at least one copolymer comprising at least one polythiophene segment and at least one RAFT group. The RAFT group can comprise a thiocarbonylthio RAFT group. The RAFT group can comprise trithiocarbonate, dithioester, dithiocarbonate or dithiocarbamate. The polythiophene segment can comprise a head-to-tail regioregular polythiophene. The polythiophene segment can comprise a head-to-tail regioregular polythiophene comprising a degree of regioregularity of at least about 90%. The polythiophene segment can be substituted in the 3-position. The polythiophene segment can be substituted in the 3-position by an alkyl, aryl, ether, or polyether substituent. The polythiophene segment can be substituted in the 3-position by an alkyl substituent.

The copolymer can be a block copolymer. The block copolymer can be a diblock or a triblock copolymer. The copolymer can be a graft copolymer.

The copolymer can comprise a non-conducting segment covalently bound to said RAFT group. The non-conducting segment can comprise a polystyrene, a poly(meth)methacrylate, or a derivative thereof.

Another important embodiment is a composition comprising a block copolymer comprising an electrically conductive polymer block, and a non-electrically conductive polymer block, wherein the two blocks are joined by a RAFT group. The electrically conductive polymer block can comprises polythiophene, including a regioregular polythiophene.

Another important embodiment is a composition comprising a block copolymer comprising a regioregular polythiophene polymer block, and a non-electrically conductive polymer block, wherein the two blocks are joined by a RAFT group.

Another important embodiment is a polythiophene RAFT agent or group comprising a polythiophene segment; and at least one RAFT end group covalently bound to said polythiophene segment. The RAFT end group can comprise a thiocarbonylthio RAFT group. The polythiophene segment can comprise regioregular polythiophene.

Another important embodiment is a method of synthesizing polythiophene block copolymer comprising: synthesizing a polythiophene RAFT agent, said RAFT agent comprises a first polymer segment comprising polythiophene and a RAFT end group covalently bound to said first polymer segment; reacting said polythiophene RAFT agent with a monomer to form a second polymer segment. The RAFT end group can comprise trithiocarbonate. Or, the RAFT end group can comprise thiocarbonylthio. The RAFT end group can comprise benzyl or phenyl.

The first polymer segment can comprise a head-to-tail regioregular polythiophene. Or, the first polymer segment can comprise polythiophene substituted at the 3-position. The first polymer segment can comprise polythiophene substituted at the 3-position by an alkyl, aryl, ether, or polyether substituent. The first polymer segment can comprise polythiophene substituted at the 3-position by an alkyl substituent. The second polymer segment can comprise a non-conducting polymer segment. The second polymer segment can comprise a non-conducting organic vinyl polymer segment.

Another important embodiment is a method of synthesizing a polythiophene RAFT agent, said method comprising: reacting a polymer segment with a non-polythiophene RAFT agent, wherein the polymer segment comprises a polythiophene segment terminated with a hydroxyl group.

Also provided are devices such as, for example, a sensor, a display, a transistor, a field effect transistor, a battery, a diode, an OLED device, or a PLED device comprising a block copolymer comprising at least one polythiophene segment and at least one RAFT group.

Another important embodiment is a polymer blend comprising a block copolymer comprising at least one polythiophene segment and at least one RAFT group. The polymer blend can further comprise a second polymer comprising polythiophene which is different from the block copolymer.

Other important embodiment include (i) polythiophene block copolymers prepared by NMRP (nitroxide mediated radical polymerization) also called NMP (nitroxide mediated polymerization) methods including with use of hydrocarbon or vinyl monomers such as isoprene to form polyisoprene segments; (ii) methods of preparing these block copolymers. NMP is a controlled radical polymerization method. Blends can also be made of an NMP-prepared polymer and a second polymer. NMP agents can be prepared wherein a polythiophene segment is terminated with an NMP group for further NMP polymerization.

These block polymers, including RAFT and NMP block copolymers, demonstrate nanowire morphology in the solid state as well as in surface features. These polymers can retain high conductivity despite the presence of the insulator in the block copolymer such as for example hydrocarbon polymers like polystyrene or polyisoprene.

A basic and novel feature of the invention, providing an important commercial advantage, is that polymer compositions can be prepared with very low levels, if any, transition metal.

### BRIEF DESCRIPTION OF THE DRAWINGS

FIG. 1 illustrates a mechanism of RAFT polymerization.

FIG. 2 is ¹H NMR spectrum of poly(3-hexylthiophene) RAFT agent.

FIG. 3 is ¹H NMR spectrum of poly(3-hexylthiophene)-b-polystyrene (42.1 mol % PHT).

FIG. 4 shows GPC traces for polymerization of styrene (THF eluent; polystyrene calibration).

FIG. 5 is a plot of molecular weight vs. conversion for RAFT polymerization of styrene.

FIG. 6. Synthesis of bromoester-terminated poly(3-alkylthiophene).

FIG. 7. Synthesis of poly(3-alkylthiophene) RAFT agent.

FIG. 8. Synthesis of poly(3-hexylthiophene)-b-polystyrene using RAFT

FIG. 9. Synthesis of Poly(3-hexylthiophene)-b-polystyrene by RAFT showing changes in conductivity from sigma=20 S/cm to 4 S/cm with block copolymer formation.

FIG. 10. AFM images of PHT-PS (40 mol % PHT) wherein 9a is height image and 9b is phase image. Conductivity sigma is 4 S/cm.

FIG. 11. Synthesis of Poly(3-hexylthiophene)-b-polyisoprene showing changes in conductivity from sigma=20 S/cm to 2 S/cm with block copolymer formation.

FIG. 12. AFM images of PHT-PI (35 mol % PHT)

FIG. 13. ¹H NMR spectrum of alkoxyamine terminated poly(3-hexylthiophene).

FIG. 14. ¹H NMR spectrum of poly(3-hexylthiophene)-b-polyisoprene (35 mol % PHT)

### DETAILED DESCRIPTION OF THE INVENTION

The publication “Living Radical Polymerization Techniques Applied to the Synthesis of well-defined copolymers containing regioregular poly(3-alkylthiophene)” by Iovu et al., Polymer Preprints, ACS Meeting, Aug. 28-31, 2005 is hereby incorporated by reference in its entirety.

The present invention is directed, generally, to electrically conductive polymers including polythiophenes, more particularly, head to tail coupled regioregular polythiophenes, copolymers containing regioregular polythiophenes, and methods of synthesizing the same, in particular, using controlled radical polymerization methods.

### Electrically Conducting Polymers Including Polythiophenes

Electrically conductive polymers and polythiophenes are generally known to those skilled in the art (see references cited in background section). Polythiophenes are described, for example, in Roncali, J., Chem. Rev. 1992, 92, 711; Schopf et al., Polythiophenes: Electrically Conductive Polymers, Springer: Berlin, 1997.

U.S. Pat. No. 6,166,172 to McCullough et al. describes an improved method for synthesis of conducting polymers including regioregular polythiophenes (GRIM methods) including larger scale methods and is hereby incorporated by reference in its entirety. See also Loewe et al., Macromolecules, 2001, 34, 4324-4333 which describes regioselectivity of these reactions.

U.S. Pat. No. 6,602,974 to McCullough et al. describes block copolymers prepared by use of tailored endgroups and is hereby incorporated by reference in its entirety including figures, claims, and working examples. The '974 patent describes a variety of non-conductive structural polymers which can be incorporated into the same polymer chain as the conductive polymer. See also, Liu et al., Macromolecules, 2002, 35, 9882-9889; Liu et al., Angew. Chem. Int. Ed., 2002, 41, No. 2, pages 329-332, which are incorporated by reference in their entirety. These references also describe important morphological aspects of block copolymers.

U.S. Provisional application Ser. No. 60/661,935 filed Mar. 16, 2005, describes making polymers, including polythiophene polymers, having unsaturated end groups, including monocapping of polymers with unsaturated end groups, and is hereby incorporated by reference in its entirety.

The degree of regioregularity can be, for example, at least about 90%, or at least about 95%, or at least about 99%. NMR methods can be used, for example, to measure the degree of regioregularity.

Chemistry and applications for conductive polymers, as described herein, can be further found in for example (i) McCullough, Adv. Mater., 1998, No. 2, pages 93-116, (ii) McCullough et al., Handbook of Conducting Polymers, 2 Ed., 1998, Chapter 9, pages 225-258.

In addition, electrically conductive polymers are described in The Encyclopedia of Polymer Science and Engineering, Wiley, 1990, pages 298-300, including polyacetylene, poly(p-phenylene), poly(p-phenylene sulfide), polypyrrole, and polythiophene, and derivatives thereof, which is hereby incorporated by reference in its entirety. This reference also describes blending and copolymerization of polymers, including block copolymer formation.

Polymeric semiconductors are described in, for example, “Organic Transistor Semiconductors” by Katz et al., Accounts of Chemical Research, vol. 34, no. 5, 2001, page 359 including pages 365-367, which is hereby incorporated by reference in its entirety.

### Reversible Addition—Fragmentation Chain Transfer Polymerization (RAFT)

RAFT polymerization is known to those skilled in the art. For example, a review of RAFT polymerization is provided in J. Chiefari and E. Rizzardo “Control of Free Radical Polymerization by Chain Transfer Methods”, pages 629-691, in Handbook of Radical Polymerization; Matyjaszewski, K.; Davis, T. P. Eds. Wiley-Interscience: Hoboken, 2002, incorporated hereby by reference in its entirety. In particular, block copolymers are described on pages 677-679. See also Controlled/Living Radical Polymerization, Progress in ATRP, NMP, RAFT, K. Matyjaszewski (Ed), ACS Symposium Series, 2000.

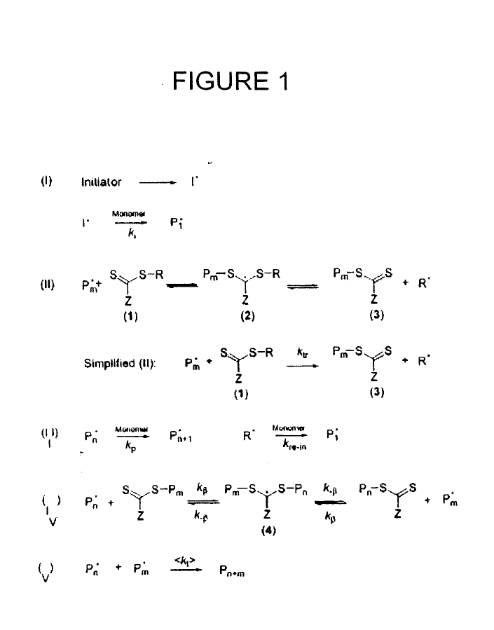

Although the present invention is not limited by theory, the principle of a RAFT process, as illustrated on FIG. 1, is centered on the equilibrium reaction (IV), in which a propagating radical Pₙ adds to the dormant species Pₘ-X to form an intermediate macroRAFT radical (4) Pₙ-(X)-Pₘ. The intermediate macroRAFT radical (4) undergoes fragmentation generating Pₘ radical (propagating species) and Pₘ-X dormant species. The intermediate macroRAFT radical (4) may also fragment to the other side to give the initial molecules Pₙ and Pₘ-X. In an ideal system, this addition fragmentation process should be fast and favor the parallel growth of the polymer chains without influencing the rate of polymerization. However, it has been reported that for some RAFT agents mediated polymerization that the rate of reaction decreases significantly when increasing the RAFT agent concentration.

Control of molecular weight and molecular weight distribution can be achieved, for example, using as X (RAFT group or RAFT agent) a variety of compounds. The RAFT group can be, for example, xanthate, dithiocarbamate, trithiocarbonate, or dithioester which each comprise thiocarbonylthio group. The use of thiocarbonylthio groups in the RAFT polymerization is described, for example, in PCT publication No. WO 98/01478 to Le et. al. and US patent publication 2004/0171777 to Le et. al. both incorporated hereby by reference. Thiocarbonylthio-containing and other thio-containing RAFT groups are also described in the following references:

1) J. Chiefari and E. Rizzardo “Control of Free Radical Polymerization by Chain Transfer Methods”, in. Handbook of radical polymerization; Matyjaszewski, K.; Davis, T. P. Eds. Wiley-Interscience: Hoboken, 2002
2) Barner-Kowollik et. al. J. Polym. Sci., Part A: Polym. Chem., 2001, v. 39, p. 1353;
3) Mayadunne et. al. Macromolecules, 2000, v. 33, 243;
4) Stenzel et. al. Macromol. Chem. Phys., 2003, 204, 1160;
5) Desterac et. al. Macromol. Rapid. Commun., 2000, 21, 1035; Moad et. al., Polym. Int. 2000, 49, 993;
6) Stenzel et. al. J. Mater. Chem. 2003, 13, 2090-2097,
7) U.S. Pat. No. 6,642,318 issued Nov. 4, 2003, to Chiefari et. al.;
8) U.S. Pat. No. 6,747,111 issued Jun. 8, 2004, to Chiefari et. al., which are all incorporated hereby by reference in their entirety.

RAFT polymerization can be also controlled using as X functional groups containing organic iodides, such as alkyl iodides, and telluro containing groups such as ditellurides, see e.g. J. Chiefari and E. Rizzardo “Control of Free Radical Polymerization by Chain Transfer Methods”, in. Handbook of radical polymerization; Matyjaszewski, K.; Davis, T. P. Eds. Wiley-Interscience: Hoboken, 2002, and references therein.

### Electrically Conducting Polymer and Polythiophene RAFT Agent

An electrically conducting polymer can be derivatized to form a RAFT agent, or a macroinitiator.

One embodiment of the invention is a polythiophene RAFT agent comprising a polythiophene segment; and at least one RAFT end group chemically or covalently bound to said polythiophene segment. The RAFT end group can be any of the RAFT groups described above, such thio containing RAFT group, organic iodide containing RAFT group or telluro containing RAFT group. Preferably, the RAFT end group is thio containing RAFT group having general formula

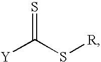

wherein Y can be substituted oxygen (xanthates), substituted nitrogen (dithiocarbamates), substituted sulfur (trithiocarbonates), substituted sulfur alkyl or aryl (dithioesters). The RAFT end group can be chemically bound to the polythiophene segment in any position. However, the polymer is preferably modified at one or both terminal positions for a linear polymer chain.

There is no particular limitation on the organic chemistry used to form the RAFT agent. For example, the following reference describes a variety of synthetic chemistries: J. Chiefari and E. Rizzardo “Control of Free Radical Polymerization by Chain Transfer Methods”, pages 629-691, in Handbook of Radical Polymerization; Matylaszewski, K.; Davis, T. P. Eds. Wiley-Interscience: Hoboken, 2002, incorporated hereby by reference in its entirety. The working examples below also provide guidance.

The polythiophene segment can comprise at least one thiophene monomer. The polythiophene segment can be, for example, a head-to-tail regioregular polythiophene. In some embodiments, the polythiophene segment can be substituted in the 3-position. The polythiophene segment can be substituted by, for example, by an alkyl, aryl, ether, or polyether substituent. In the preferred embodiment, the polythiophene segment can comprise a head-to-tail regioregular 3-alkyl polythiophene.

### Polythiophene Polymer or Copolymer Comprising RAFT Group

Another embodiment of the invention is a polythiophene polymer or copolymer comprising at least one polythiophene segment and at least one RAFT group. The polythiophene copolymer can be a well defined copolymer with polydispersity index (PDI) of less than about 1.5, more preferable less than about 1.3, more preferably less than about 1.2, most preferably less than about 1.1. The number average molecular weight of the polythiophene copolymer can be at least 8,000, more preferably at least 10,000, more preferably at least 14,000, more preferably at least 18,000, most preferably at least about 25,000.

In general, soluble polymers are preferred. Alternatively, the polymer can be a highly dispersed nanoparticulate material which may behave in some respects as if it was soluble. For purposes of the present invention and commercial applications, that distinction is not important.

Metal content in the final polymer can be very low, e.g, less than 1,000 ppm, or less than 500 ppm, or less than 100 ppm, or less than 10 ppm, or less than 1 ppm. For example, atomic absorption can be used to measure metal content.

The polythiophene polymer or copolymer can be random/statistical copolymer, gradient copolymer, block copolymer, graft copolymer or star polymer or copolymer. The random/statistical copolymer can have more than one different monomers randomly distributed along the polymer chain. The gradient copolymer comprising monomers A and B can have a fraction of polymer A varying smoothly from pure A on one end to pure B on the other. Graft copolymers belong to general class of segmented copolymers and have a sequence of one monomer grafted onto the backbone of the second monomer type, see e.g. F. W. Billmeyer, Textbook Of Polymer Chemistry, 1984, John Wiley & Sons, New York, page 120-122. Star polymers comprise a branch point and a plurality linear chains branching from it.

In some embodiments the polythiophene polymer or copolymer can be a block copolymer. Block copolymers are generally known in the art. See for example Yang (Ed.), The Chemistry of Nanostructured Materials, 2003, pages 317-327 (“Block Copolymers in Nanotechnology”). Also block copolymers are described in, for example, Block Copolymers, Overview and Critical Survey, by Noshay and McGrath, Academic Press, 1977. For example, this text describes A-B diblock copolymers (chapter 5), A-B-A triblock copolymers (chapter 6), and -(AB)ₙ-multiblock copolymers (chapter 7), which can form the basis of block copolymer types in the present invention. Additional block copolymers including polythiophenes are described in, for example, Francois et al., Synth. Met. 1995, 69, 463-466, which is incorporated by reference in its entirety; Yang et al., Macromolecules 1993, 26, 1188-1190; Widawski et al., Nature (London), vol. 369, Jun. 2, 1994, 387-389; Jenekhe et al., Science, 279, Mar. 20, 1998, 1903-1907; Wang et al., J. Am. Chem. Soc. 2000, 122, 6855-6861; Li et al., Macromolecules 1999, 32, 3034-3044; Hempenius et al., J. Am. Chem. Soc. 1998, 120, 2798-2804.

The polythiophene segment of the polythiophene polymer or copolymer comprises at least one thiophene monomer. The polythiophene segment of the polythiophene polymer or copolymer can be, for example, a head-to-tail regioregular polythiophene. In some embodiments, the polythiophene segment can be substituted in the 3-position. The polythiophene segment can be substituted by, for example, by an alkyl, aryl, ether, or polyether substituent. In the preferred embodiment, the polythiophene segment can comprise a head-to-tail regioregular 3-alkyl polythiophene. In another embodiment, the side group can comprise one or more heteroatoms such as oxygen or nitrogen. For example, alkoxy or alkoxyalkoxy or alkoxyalkoxyalkoxy groups can be used. Ethyleneoxy and propyleneoxy groups can be used. The polythiophene segment can be in a doped or undoped state.

In some embodiments, the polythiophene copolymer can comprise a non conductive segment. In some embodiments, the polythiophene copolymer can comprise a conductive segment. The non-conductive segment can include both condensation, addition, and ring-opened polymers including for example, urethanes, polyamides, polyesters, polyethers, vinyl polymers, aromatic polymers, aliphatic polymers, heteroatom polymers, siloxanes, acrylates, methacrylates, phosphazene, silanes, and the like.

The RAFT group can be any of the RAFT groups described above. Preferably, the RAFT group is a thio containing group, such as xanthate, dithiocarbamate, trithiocarbonate, or dithioester. After polymerization, the RAFT group remains in the polymer. For an A-B block copolymer, it connects the A and B groups. One skilled in the art recognizes that the RAFT group will have terminal groups like phenyl which will be cleaved off during polymerization, but the RAFT group remains with the original polymer as polymerization progresses.

### Methods

Another embodiment of the present invention is a method of synthesizing polythiophene polymers and copolymers comprising synthesizing a polythiophene RAFT agent, said RAFT agent comprises a first polymer segment comprising polythiophene and a RAFT end group covalently or chemically bound to said first polymer segment; reacting said polythiophene RAFT agent with a monomer to form a second polymer segment.

The method can be used for synthesizing well defined polymers and copolymers including random/statistical copolymers, gradient copolymers, block copolymers, graft copolymers and star polymers and copolymers.

Synthesis of random/statistical copolymers using RAFT polymerization is described, for example, in Rizzardo et. al. Macromol. Symp. 143, 291 (1999); J. Chiefari and E. Rizzardo “Control of Free Radical Polymerization by Chain Transfer Methods”, in. Handbook of Radical Polymerization; Matyjaszewski, K.; Davis, T. P. Eds. Wiley-Interscience: Hoboken, 2002, both incorporated hereby by reference in their entirety. Synthesis of gradient copolymers using RAFT polymerization is described, for example, Rizzardo et. al. Macromol. Symp. 143, 291 (1999), J. Chiefari and E. Rizzardo “Control of Free Radical Polymerization by Chain Transfer Methods”, in. Handbook of Radical Polymerization; Matyjaszewski, K.; Davis, T. P. Eds. Wiley-Interscience: Hoboken, 2002, both incorporated hereby by reference in its entirety.

For synthesizing of star polymers the RAFT agent can comprise multiple RAFT groups. RAFT synthesis of star polymers is described, for example, in Y. K. Chong et. al. Macromolecules 32, 201 (1999), E. Rizzardo et. al. ACS Symp. Ser. 768, 278 (2000), R. T. A. Mayadunne et. al. Macromolecules 2003; 36(5); 1505-1513; J. Chiefari and E. Rizzardo “Control of Free Radical Polymerization by Chain Transfer Methods”, in. Handbook of Radical Polymerization; Matyjaszewski, K.; Davis, T. P. Eds. Wiley-Interscience: Hoboken, 2002, Stenzel et. al. J. Mater. Chem. 2003, 13, 2090-2097, all incorporated hereby by reference.

Synthesis of various block copolymers using RAFT process is described, for example, in J. Chiefari and E. Rizzardo “Control of Free Radical Polymerization by Chain Transfer Methods”, in. Handbook of Radical Polymerization; Matyjaszewski, K.; Davis, T. P. Eds. Wiley-Interscience: Hoboken, 2002; T. P. Le et. al. WO 9801478; Y. K. Chong et. al. Macromolecules 32, 2071 (1999), E. Rizzardo et. al. ACS Symp. Ser. 768, 278 (2000), R. T. A. Mayadunne et. al. Macromolecules 32, 6977 (1999), all incorporated hereby by reference in their entirety.

Reacting the polythiophene RAFT agent with the monomer for the second polymer segment can be carried out at temperature ranging from about 20° C. to about 120° C., more preferably from about 50° C. to about 100° C., more preferably from about 65° C. to about 75° C.

Reacting the polythiophene RAFT agent with the second polymer segment can comprise adding an initiator to the reaction.

In some embodiments, the second polymer segment can comprise be a conducting segment. In some embodiments, the second polymer segment can comprised a non-conducting segment. The conducting segment can be, for example, a conducting polymer segment such polyaniline, polypyrrole, polyphenylenevinylene, polyacetylene and the like. The non-conductive segment can include both condensation, addition, and ring-opened polymers including for example, urethanes, polyamides, polyesters, polyethers, vinyl polymers, aromatic polymers, aliphatic polymers, heteroatom polymers, siloxanes, acrylates, methacrylates, phosphazene, silanes, and the like.

Yet still another embodiment is a method of synthesizing a polythiophene RAFT agent, said method comprising reacting a polymer segment with a non-polythiophene RAFT agent, wherein the polymer segment comprises a polythiophene segment. In some embodiments, polythiophene segment can comprise hydroxyl end group. The non-polythiophene RAFT agent can be any RAFT agent not comprising a thiophene group. Preferably, the non-polythiophene RAFT agent comprises a thio containing RAFT group such as such as xanthate, dithiocarbamate, trithiocarbonate, or dithioester. The reaction between the polymer segment and the non-polythiophene RAFT agent can be carried out in the presence of a catalyst. The catalyst can be, for example, pyridine.

### NMP Embodiment

Another embodiment provides a method of synthesizing polythiophene block copolymer comprising: synthesizing a polythiophene NMP agent, said NMP agent comprises a first polymer segment comprising polythiophene and a NMP end group covalently bound to said first polymer segment; reacting said polythiophene NMP agent with a monomer to form a second polymer segment. Related patents include for example U.S. Pat. Nos. 5,910,549; 6,288,186; 6,512,060; and 6,541,580 to Matyjaszewski et al., which are hereby incorporated by reference in their entirety. See additionally, Controlled/Living Radical Polymerization, Matyjaszewski, supra. In particular, alkoxyamine macroinitiators can be used to form NMP materials.

The monomer can be a monomer that can be polymerized by NMP methods including unsaturated compounds sensitive to radical polymerization. In one embodiment, the monomer is a hydrocarbon monomer or a vinyl monomer such as for example isoprene.

In one embodiment, the polythiophene is a regioregular polythiophene. The degree of regioregularity can be at least 90%, or at least 95%.

Another embodiment provides a polythiophene copolymer composition comprising at least one copolymer comprising at least one polythiophene segment and at least one NMP group, wherein the NMP group is a group associated with initiating NMP polymerization. The NMP group can be for example a —OC(O)— as also can be found in ATRP and RAFT structures as well as nitroxide groups. The nitroxide group at the polymer chain end can remain on the polymer or be cleaved off the polymer.

In one embodiment, the polythiophene segment is a regioregular polythiophene segment.

As with the RAFT polymers, these NMP polymers can be characterized, the structure modified, blended and used in applications.

Additional description is provided in the working examples below.

### Morphology and Conductivity

Surface morphology of polymer films can be visualized with tapping mode atomic force microscopy (TMAFM). Nanofibrilar morphology can be observed for thin films of block copolymers prepared by for example drop casting from solvent.

Bulk morphology can be examined by grazing incidence small-angle X-ray scattering (GISAXS). Periodicity can be observed in some cases.

Relatively high conductivities can be achieved even at low content of conducting polymer.

### Applications

The polythiophene polymers and copolymers synthesized using methods of the present invention can be useful in a number of commercially important applications. The applications of these materials are not particularly limited but include optical, electronic, semiconducting, electroluminescent, photovoltaic, LEDs, OLEDs, PLEDs, hole injection layers, hole transport layers, sensors, transistors including field-effect transistors, batteries, flat screen displays, organic lighting, printed electronics, nonlinear optical materials, dimmable windows, RFID tags, fuel cells, and others. See for example Kraft et al., Angew. Chem. Int Ed., 1998, 37, 402-428 and discussion of applications which is hereby incorporated by reference in its entirety. See also, Shinar, Organic Light-Emitting Devices, Springer-Verlag, 2004. See also U.S. Pat. No. 6,602,974 patent noted above. Hole-injection layers can be fabricated. Multilayer structures can be fabricated and thin film devices made. Thin films can be printed. Patterning can be carried out. Printing on consumer products can be carried out. Small transistors can be fabricated. In many applications, the composition is formulated to provide good solution processing and thin film formation.

Water soluble conducting polymers are of particular interest including for use in biological applications. Polymers can be prepared by the methods described herein such as those in Balamurugan et al., Angew. Chem. Int. Ed., 2005, 44, 4872-4876, which is incorporated by reference in its entirety.

The invention is further illustrated by, though in no way limited to, the following examples.

### WORKING EXAMPLES

### Example 1

### RAFT

### Synthesis of vinyl- or allyl-terminated PHT

4.9 g (15 mmol) 2,5-dibromo-3-hexylthiophene was dissolved in 150 mL of dry THF. 7.5 mL (15 mmol) solution of alkylmagnesium chloride (2 M) in diethyl ether was added via syringe under nitrogen and the reaction mixture was stirred at reflux for 90 minutes. The reaction mixture was cooled to room temperature and 0.15 g (0.27 mmol) of Ni(dppp)Cl₂ catalyst was added. The mixture was stirred for additional 10 minutes at room temperature followed by the addition of 3 mL (3 mmol) solution of allyl- or vinylmagnesium bromide (1 M). After 5 minutes, the reaction mixture was poured into methanol and the polymer precipitated.

Hydroboration/Oxidation of Vinyl Terminated PHT

2 g (0.2 mmol; Mₙ(NMR)=10000) vinyl-terminated PHT was dissolved in 100 mL of dry THF. 4 mL (2 mmol) of 9-BBN solution (0.5 M) in THF was added under nitrogen. The reaction mixture was stirred for 24 hours at 40° C. 2 mL of NaOH solution (6 M) was then added to the reaction flask under nitrogen. The reaction mixture was stirred for an additional 15 minutes and cooled to room temperature. 2 mL of hydrogen peroxide solution (33%) was added to the reaction mixture and the reaction stirred for 24 hours at 40° C. The hydroxy-terminated PHT was isolated by precipitation in methanol. The polymer was filtered and purified by a Soxhlet extraction with methanol.

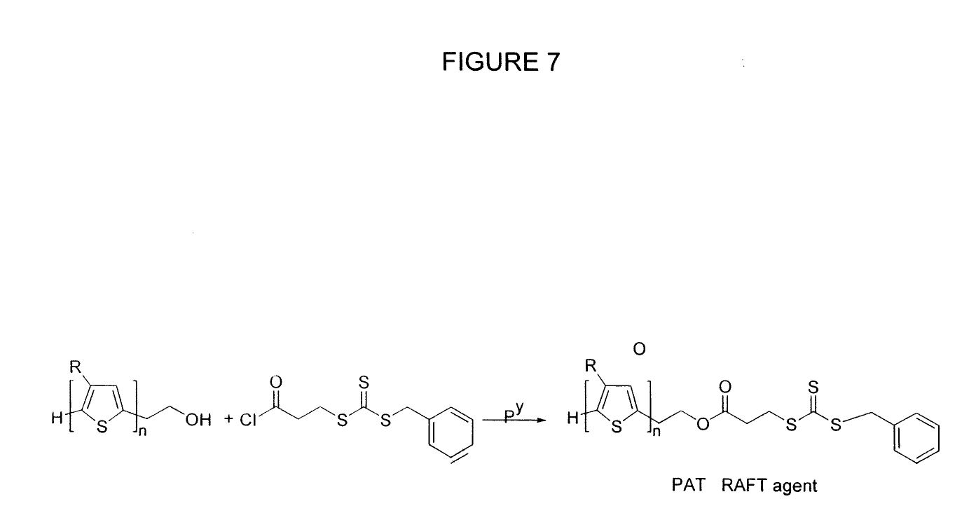

Poly(3-hexylthiophene) RAFT agent was synthesized from hydroxyethyl-terminated polymer according to FIG. 7. The synthesis of 3-benzylsulfanylthiocarbonylsulfanylpropionic acid chloride used in this reaction was carried out according to a procedure described in Stenzel, M. H., Davis, T. P., Fane, A. G., J. Mater. Chem. 2003, 13, 2090, incorporated hereby by reference in its entirety.

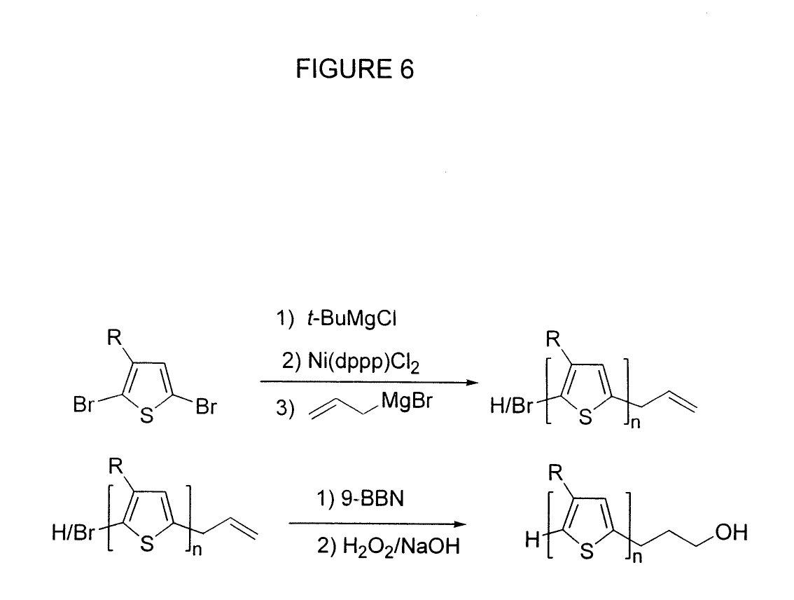

The synthesis of hydroxy-terminated poly(3-hexylthiophene) is shown in FIG. 6.

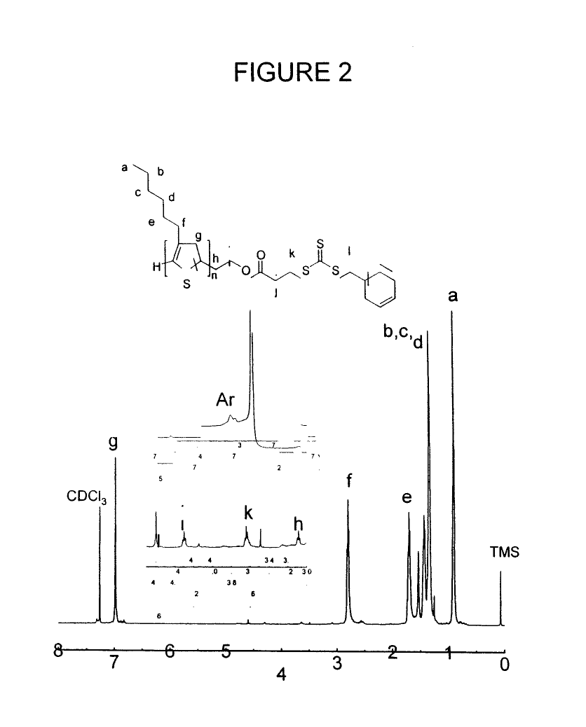

Reaction of 3-benzylsulfanylthiocarbonylsulfanylpropionic acid chloride with hydroxyethyl (hydroxypropyl) terminated poly(3-hexylthiophene), in the presence of pyridine, yielded poly(3-hexylthiophene) RAFT agent (FIG. 7). ¹H NMR spectrum shown in FIG. 2 demonstrates that poly(3-hexylthiophene) RAFT agent was indeed synthesized.

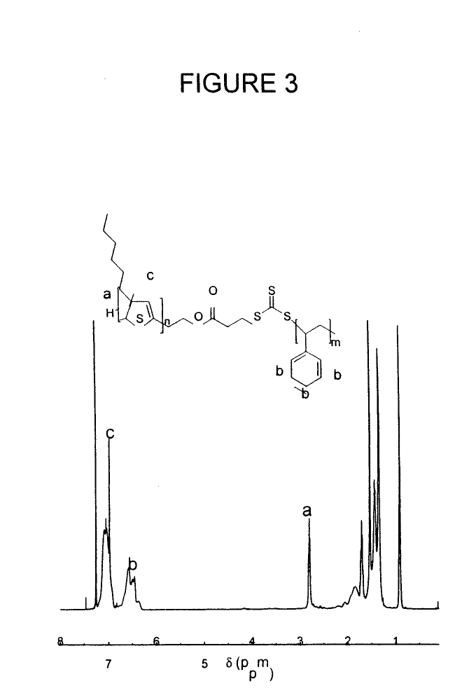

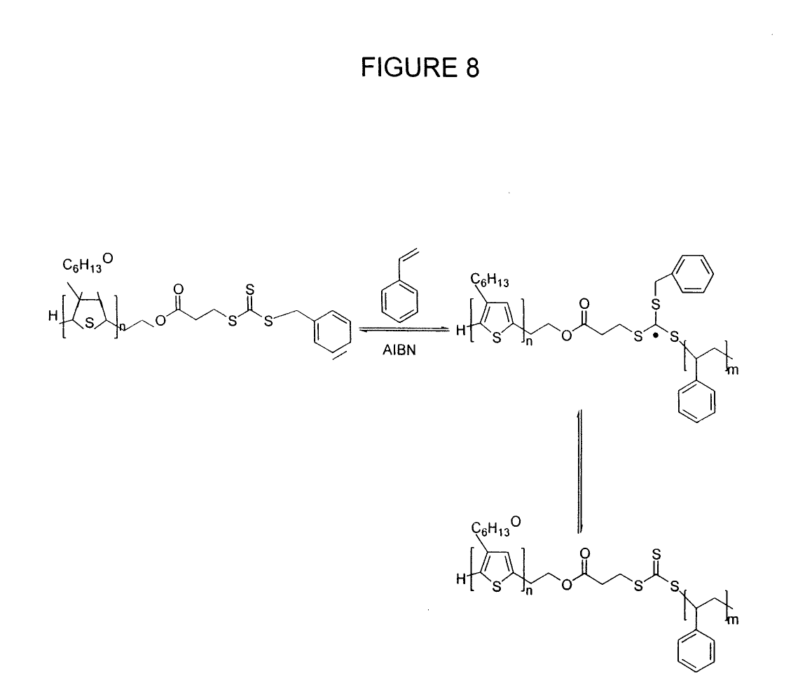

Polymerization of styrene using PHT RAFT agent was performed in the presence of 2,2′-azobis(2-methylpropionitrile) (AIBN) initiator at 70° C. (FIG. 8). Reagent were mixed using the following ratio:[Styrene]:[PHT-RAFT]:[AIBN]=400:1:0.3. RAFT polymerization was performed at 70° C. using Trichlorobenzene (TCB) as a solvent. The ratio [Styrene]:[TCB] was equal 2:1. ¹H NMR spectrum of resultant material shown in FIG. 3 demonstrates that poly(3-hexylthiophene)-b-polystyrene copolymer was indeed synthesized.

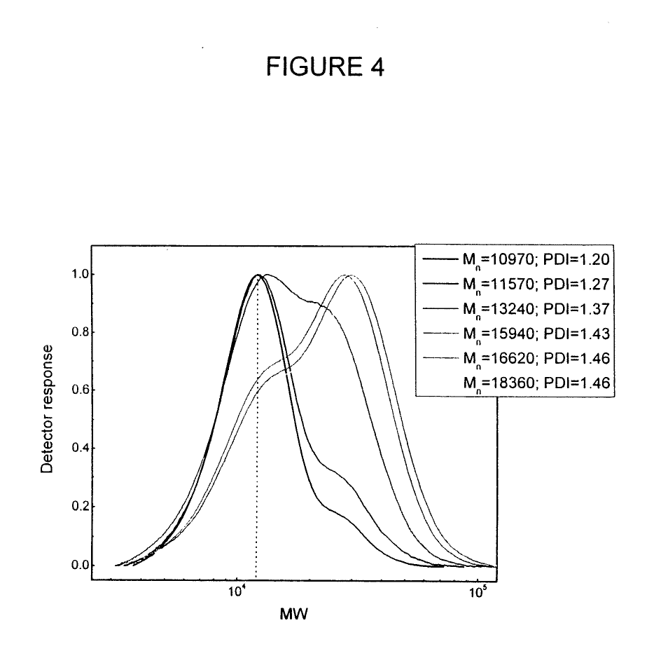

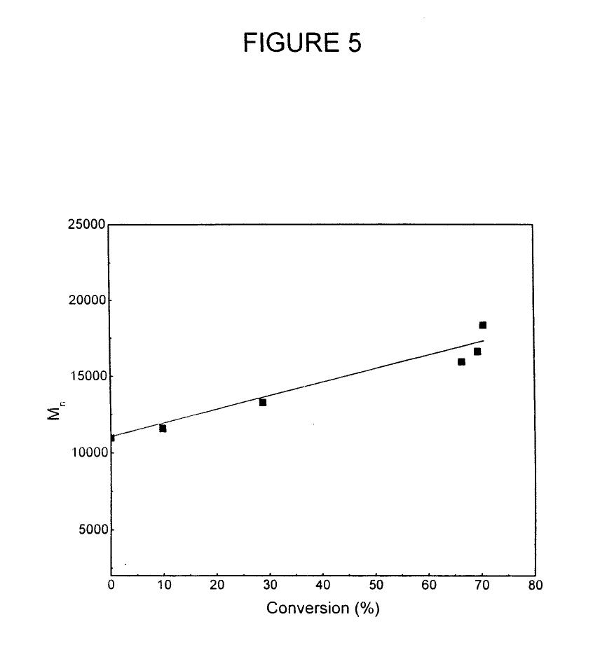

Table 1 summarizes the results of the polymerization. The first column is the time of polymerization, the second and third columns are molecular weight percentages of PHT and polystyrene respectively the fourth column is the number average molecular weight determined by gel permeation chromatography (GPC), the fifth column presents GPC determined polydispersity indices (PDI). GPC traces used for determining data presented in the fourth and fifth columns of Table 1 are presented in FIG. 4. The GPC was performed using tetrahydrofuran (THF) as eluent. The calibration of GPC was done using polystyrene. FIG. 5 presents molecular weight versus conversion for RAFT polymerization of styrene. The linearity of this plot demonstrates the living nature of the RAFT process.

TABLE 1

| Reaction time | | | | |
|---|---|---|---|---|
| (s) | mol % PHT | mol % PSt | Mn (GPC) | PDI (GPC) |
| 0 | 100 | 0 | 10970 | 1.20 |
| 4500 | 91.8 | 8.2 | 11570 | 1.27 |
| 8700 | 76.1 | 23.9 | 13240 | 1.37 |
| 37500 | 44.6 | 55.4 | 15940 | 1.43 |
| 74700 | 42.1 | 57.9 | 16620 | 1.46 |
| 91200 | 41.2 | 58.8 | 18360 | 1.46 |

In sum, polythiophene RAFT agent was synthesized and characterized. New block copolymers based on regioregular poly(3-alkylthiophene) were synthesized via RAFT polymerization. The living nature of the RAFT polymerization was demonstrated.

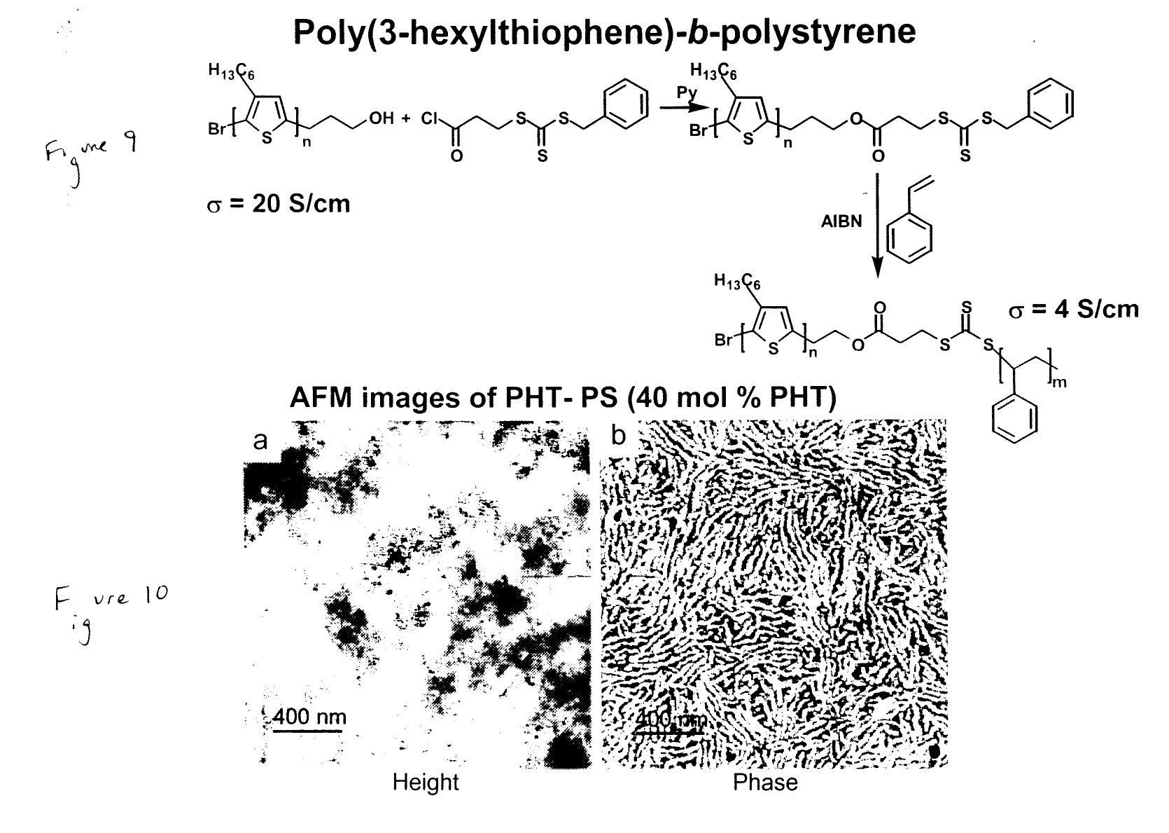

FIG. 9 illustrates the synthetic morphology used to prepare the AFM images shown in FIG. 10, as well as the conductivity (σ, S/cm) of the polymers. The nanowire morphology can be seen.

### Example 2

### NMP Polymerization

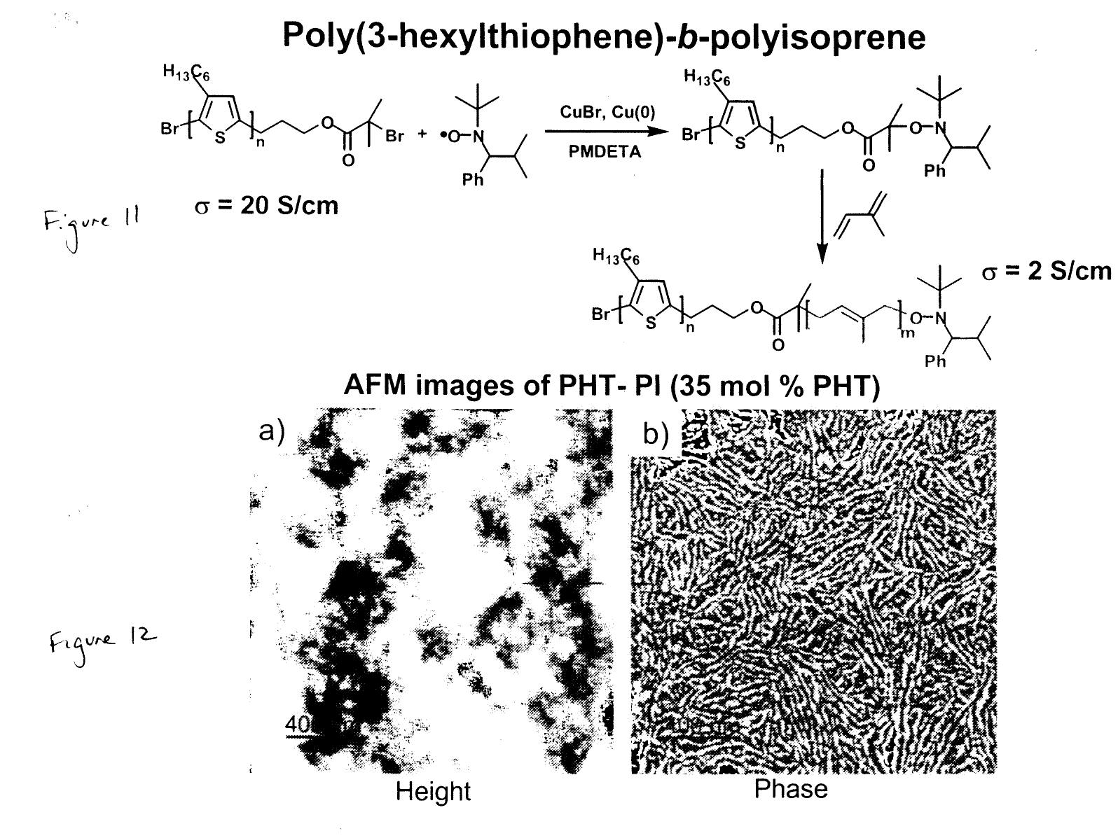

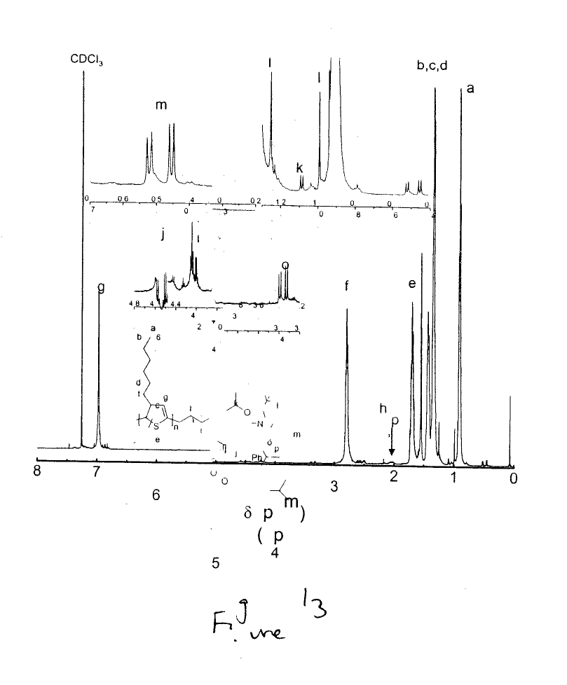

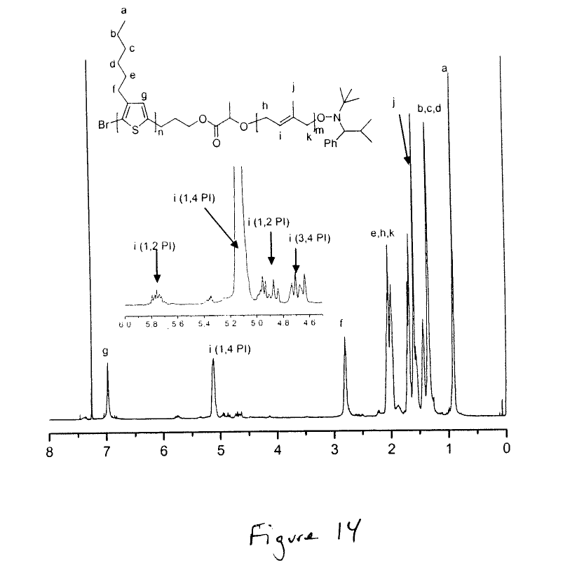

FIGS. 11-14 illustrate this embodiment. FIG. 11 shows the synthesis and conductivity. FIG. 12 illustrates AFM images and nanowire morphology. FIGS. 13 and 14 provide NMR spectral characterization.

General Procedure For Synthesis Of Alkoxyamine Terminated Poly(3-Hexylthiophene) (5) (alkoxyamine macroinitiator).

2,2,5-Trimethyl-4-phenyl-3azahexane-3-oxy (TIPNO) was prepared according to literature procedures (Benoit et al., J. Am. Chem. Soc. 1999, 121, 3904). Bromoester terminated poly(3-hexylthiophene) (0.5 g, 0.075 mmol) was dissolved in anhydrous toluene (20 mL) under nitrogen. Copper (I) bromide (14.3 mg, 0.1 mmol), copper powder (6 mg, 0.9 mmol), N,N, N′,N′,N″-pentamethyldiethylenetriamine (PMDETA) (42 μL, 0.2 mmol) and TIPNO (33 mg, 0.15 mmol) were added to the polymer solution under nitrogen. The system was degassed by three freeze-pump-thaw cycles and backfilled with nitrogen. The reaction mixture was heated to 80° C. for 40 h, followed by cooling down at room temperature and precipitation in methanol. The polymer was purified by sequential Soxhlet extractions with methanol and pentane. Polymer was characterized by ¹H NMR (see FIG. 13).

Nitroxide mediated radical polymerization (NMRP) of isoprene using alkoxyamine macroinitiator (alkoxyamine terminated poly(3-hexylthiophene)).

NMP of isoprene was performed using alkoxyamine terminated poly(3-hexylthiophene) as macroinitiator. Isoprene was distilled from calcium hydride and collected over molecular sieves. The molar ratio was [Iso]: [PHT-NO]=1100:1. A glass pressure vessel was charged in a glovebox with alkoxyamine terminated poly(3-hexylthiophene) (0.3 g, 0.045 mmol), isoprene (5.0 mL, 49.5 mmol) and toluene (10 mL). The reaction mixture was heated to 110° C. in a thermostated oil bath, for 40 h. After the reaction was complete the mixture was allowed to cool at room temperature and the polymer was recovered by precipitation in methanol. Characterization is provided in FIG. 14.

### Reaction Conditions for NMP:

[Iso]₀:[PHT-NO]₀=1100:1; [Iso]:[Tol]=1:2; 110° C.

The polymerization results are presented in the Table II below.

TABLE II
Experimental results for NMRP of isoprene using alkoxyamine
terminated poly(3-hexylthiophene) as macroinitiator.

| Time (h) | mol % PHT | mol % PI | Mₙ(GPC) | PDI (GPC) |
|---|---|---|---|---|
| 0 | 100 | 0 | 11600 | 1.28 |
| 40 | 35 | 65 | 20300 | 1.80 |

The microstructure of the polyisoprene block was estimated from ¹H NMR (FIG. 14). The polyisoprene block contains approximately 90% 1,4-units (cis and trans), 5% 1,2-units and 5% 3,4-units.

### General:

Materials. All reactions were conducted under prepurified nitrogen or argon, using oven-dried glassware. All glassware was assembled while hot and cooled under nitrogen or argon. Commercial chemicals, purchased from Aldrich Chemical Co., Inc., were used without further purification unless noted otherwise. All solvents were freshly distilled prior to use. Tetrahydrofuran (THF) was distilled from sodium benzophenone ketyl, Titration of the Grignard reagents was performed following the procedure described by Love et al., J. Org. Chem., 1999, 64, 3755. Methyl methacrylate, t-butyl methacrylate, isobornyl methacrylate and styrene were purified by passing through basic alumina and collected over molecular sieves under nitrogen. Isoprene was distilled from calcium hydride and collected over molecular sieves.
Measurements. ¹H and ¹³C NMR spectra were recorded in deuterated chloroform (CDCl₃) as solvent containing 0.003% TMS as an internal reference, on a Bruker Avance 500 MHz spectrometer. GC/MS was performed on a Hewlett-Packard 59970 GC/MS workstation. The GC column was a Hewlett-Packard fused silica capillary column cross-linked with 5% phenylmethyl siloxane. Helium was the carrier gas (1 mL/min). Unless otherwise noted, the following conditions were used for all GC/MS analyses: Injector temperature, 250° C.; initial temperature, 70° C.; temperature ramp, 10° C./min; final temperature, 300° C. Gel Permeation Chromatography (GPC) analysis was performed on a Waters 2690. Separations Module apparatus and a Waters differential refractometer with tetrahydrofuran as the eluent (flow rate 1.0 mL/min, 35° C.) with a series of three Styragel columms (10⁵, 10³, 100 Å; Polymer Standard Services). Calibration based on polystyrene standards was applied for determination of molecular weights and toluene was used as an internal standard.
Electrical conductivity measurements were conducted on thin polymer films by the standard spring-loaded pressure-contact four-point probe method at ambient conditions. The polymer solutions in anhydrous toluene (5 mg mL⁻¹) were filtered through PTFE 0.45 μm filter and drop cast onto 22 mm sq cover glass. The cover slips were covered with a glass dish to prevent rapid evaporation of the solvent. The films were oxidized by exposure to iodine vapors for 1 hour. At least 5 times of repeating measurement were taken for a selected, most uniform film area. The film thickness (cross-section) was measured by profilometry and the conductivity σ [5 cm⁻¹] calculated according to the following equation:

σ=1÷4.53*R*l

where R is the resistance (R=V/I) [Ω] and l is the film thickness [cm].
Tapping Mode Atomic Force Microscopy: TMAFM studies were carried out with the aid of a Nanoscope III-M system (Digital Instruments, Santa Barbara, Calif.), equipped with a J-type vertical engage scanner. The AFM observations were performed at room temperature in air using silicon cantilevers with nominal spring constant of 50 N/m and nominal resonance frequency of 300 kHz (standard silicon TESP probes). A typical value of AFM detector signal corresponding to an r.m.s. cantilever oscillation amplitude was equal to −1 to 2 V and the images were acquired at 2 Hz scan frequency in 2×2 dm² scan areas.

### Example III

Table III provides electrical conductivity for a series of polymers:

TABLE III
Electrical conductivities of poly(3-hexylthiophene) copolymers.

| | mol % | | | Film |
|---|---|---|---|---|
| Polymer | PHT | Mₙ/PDI (GPC) | σ (S/cm) | thickness (μm) |
| PHT-OH | 100 | 9000 (1.16) | 20 | 0.45 |
| PHT-b-PS | 40 | 18400 (1.46) | 4.0 | 1.2 |
| PHT-b-PI | 35 | 20300 (1.9) | 2.0 | 2.0 |

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed is:

1. A polythiophene copolymer composition comprising at least one copolymer comprising at least one polythiophene segment and at least one RAFT group.

2. The composition of claim 1, wherein said RAFT group comprises a thiocarbonylthio RAFT group.

3. The composition of claim 1, wherein said RAFT group comprises trithiocarbonate, dithioester, dithiocarbonate or dithiocarbamate.

4. The composition of claim 1, wherein said polythiophene segment comprises a head-to-tail regioregular polythiophene.

5. The composition of claim 1, wherein said polythiophene segment comprises a head-to-tail regioregular polythiophene comprising a degree of regioregularity of at least about 90%.

6. The composition of claim 1, wherein said polythiophene segment is substituted in the 3-position.

7. The composition of claim 1, wherein said polythiophene segment is substituted in the 3-position by an alkyl, aryl, ether, or polyether substituent.

8. The composition of claim 1, wherein said polythiophene segment is substituted in the 3-position by an alkyl substituent.

9. The composition of claim 1, wherein said copolymer is a block copolymer.

10. The composition of claim 9, wherein said block copolymer is a diblock or a triblock copolymer.

11. The composition of claim 1, further comprising a non-conducting segment chemically bound to said RAFT group.

12. The composition of claim 11, wherein said non-conducting segment comprises a polystyrene, a poly(meth)methacrylate, or a derivative thereof.

13. A composition comprising a block copolymer comprising an electrically conductive polymer block, and a non-electrically conductive polymer block, wherein the two blocks are joined by a RAFT group.

14. The composition according to claim 13, wherein the electrically conductive polymer block comprises polythiophene.

15. The composition according to claim 13, wherein the electrically conductive polymer block comprises regioregular polythiophene.

16. A composition comprising a block copolymer comprising a regioregular polythiophene polymer block, and a non-electrically conductive polymer block, wherein the two blocks are joined by a RAFT group.

17. A polythiophene RAFT agent comprising
a polythiophene segment; and
at least one RAFT end group covalently bound to said polythiophene segment.

18. The polythiophene RAFT agent of claim 17, wherein said RAFT end group comprises a thiocarbonylthio RAFT group.

19. The polythiophene RAFT agent of claim 17, wherein said polythiophene segment comprises regioregular polythiophene.

20. A method of synthesizing polythiophene block copolymer comprising
synthesizing a polythiophene RAFT agent, said RAFT agent comprises a first polymer segment comprising polythiophene and a RAFT end group covalently bound to said first polymer segment;
reacting said polythiophene RAFT agent with a monomer to form a second polymer segment.

21. The method of claim 20, wherein said RAFT end group comprises trithiocarbonate.

22. The method of claim 20, wherein said RAFT end group comprises thiocarbonylthio.

23. The method of claim 20, wherein said RAFT end group comprises benzyl or phenyl.

24. The method of claim 20, wherein said first polymer segment comprises a head-to-tail regioregular polythiophene.

25. The method of claim 20, wherein said first polymer segment comprises polythiophene substituted at the 3-position.

26. The method of claim 20, wherein said first polymer segment comprises polythiophene substituted at the 3-position by an alkyl, aryl, ether, or polyether substituent.

27. The method of claim 20, wherein said first polymer segment comprises polythiophene substituted at the 3-position by an alkyl substituent.

28. The method of claim 20, wherein said second polymer segment is a non-conducting polymer segment.

29. The method of claim 20, wherein said second polymer segment is a non-conducting organic vinyl polymer segment.

30. A method of synthesizing a polythiophene RAFT agent, said method comprising reacting a polymer segment with a non-polythiophene RAFT agent, wherein the polymer segment comprises a polythiophene segment terminated with a hydroxyl group.

31. A sensor comprising a block copolymer comprising at least one polythiophene segment and at least one RAFT group.

32. A display comprising a block copolymer comprising at least one polythiophene segment and at least one at least one RAFT group.

33. A transistor comprising a block copolymer comprising at least one polythiophene segment and at least one RAFT group.

34. A battery comprising a block copolymer comprising at least one polythiophene segment and at least one RAFT group.

35. A diode comprising a block copolymer comprising at least one polythiophene segment and at least one RAFT group.

36. A device comprising a block copolymer comprising at least one polythiophene segment and at least one RAFT group.

37. A polymer blend comprising a block copolymer comprising at least one polythiophene segment and at least one RAFT group.

38. The polymer blend according to claim 37, further comprising a second polymer comprising polythiophene which is different from the block copolymer.

39. A method of synthesizing polythiophene block copolymer comprising
synthesizing a polythiophene NMP agent, said NMP agent comprises a first polymer segment comprising polythiophene and a NMP end group covalently bound to said first polymer segment;
reacting said polythiophene NMP agent with a monomer to form a second polymer segment.

40. The method according to claim 39, wherein the monomer is a hydrocarbon monomer.

41. The method according to claim 39, wherein the monomer is a vinyl monomer.

42. The method according to claim 39, wherein the polythiophene is a regioregular polythiophene.

43. The method according to claim 39, further comprising the step of reacting the second polymer segment with an additional monomer to form an additional polymer segment.

44. The method according to claim 43, wherein the further monomer is styrene or a styrene derivative.

45. A polythiophene copolymer composition comprising at least one copolymer comprising at least one polythiophene segment and at least one NMP group.

46. A polythiophene copolymer composition according to claim 45, further comprising a non-conducting segment chemically bound to the NMP group.

47. The polythiophene copolymer according to claim 45, wherein the polythiophene segment is a regioregular polythiophene segment.

48. The polythiophene copolymer according to claim 45, wherein the copolymer is nitroxide terminated.

49. The polythiophene copolymer according to claim 45, wherein the polythiophene segment is substituted in the 3-position.

50. The polythiophene copolymer according to claim 45, wherein the polythiophene copolymer is a block copolymer.

51. A polythiophene NMP agent comprising at least one polythiophene segment and at least one NMP group as an end group capable of NMP polymerization.

52. A block copolymer comprising at least two segments, wherein one segment is a polythiophene segment, and the block copolymer is terminated by a nitroxide group.
